(19) United States
(12) Patent Application Publication
(10) Pub. No.: US 2021/0089470 A1
(43) Pub. Date: Mar. 25, 2021

(54) ADDRESS TRANSLATION METHODS AND SYSTEMS

(71) Applicant: Alibaba Group Holding Limited, Georgetown (KY)

(72) Inventors: Ziyi HAO, Hangzhou (CN); Xiaoyan XIANG, Shanghai (CN); Feng ZHU, Hangzhou (CN)

(21) Appl. No.: 17/022,829

(22) Filed: Sep. 16, 2020

(30) Foreign Application Priority Data
Sep. 23, 2019 (CN) 201910901082.X

(51) Int. Cl. G06F 12/1045; G06F 12/0882; G06F 12/1009; G06F 12/0873

(52) U.S. Cl. CPC G06F 12/1063; G06F 12/0873; G06F 12/1009; G06F 12/0882

(57) ABSTRACT

A storage management apparatus, a storage management method, a processor, and a computer system are disclosed. The storage management apparatus includes: a translation look-aside buffer configured to store a plurality of cache entries; an address translation unit configured to translate a virtual address specified by a translation request to a corresponding translation address based on one of the plurality of cache entries; and a control unit coupled to at least one translation look-aside buffer and configured to expand an address range mapped to the selected cache entry. According to embodiments of this disclosure, a translatable address range of the translation look-aside buffer can be expanded, a hit rate of the translation look-aside buffer can be increased, and an execution time of address translation can be reduced, thereby improving performance of the processor and the system.

### CROSS-REFERENCE TO RELATED APPLICATIONS

This application claims priority to Chinese Patent Application No. 201910901082.X filed Sep. 23, 2019, which is incorporated herein in its entirety.

### TECHNICAL FIELD

The present invention relates to the processor field, and more specifically, to a storage management apparatus, a storage management method, a processor, and a computer system.

### BACKGROUND OF THE INVENTION

In a computer system supporting a virtual storage mechanism, data may be specified by using a virtual address (also referred to as a valid address, a logical address, a virtual address, or VA for short), and virtual storage space of the computer system may be managed by using a plurality of virtual addresses. The virtual address needs to be translated into a physical address (also referred to as an actual address, a real address, a physical address, or PA for short) during memory access. To implement address translation, the computer system needs to store a large number of entries, and each entry is used for translating virtual addresses of a specified range to corresponding physical addresses.

In order to speed up the process of address translation, a translation look-aside buffer (Translation Look-aside Buffer, TLB) may be used for caching some entries stored in the computer system, so as to avoid lookup in all entries stored in the computer system during each address translation process.

If a to-be-translated virtual address matches (referred to as hit or match) one of the entries in the TLB cache, the computer system can directly implement address translation by using the TLB, with no need to look up an entry outside the TLB. If the to-be-translated virtual address does not match (referred to as miss or mismatch) any of the entries cached in the TLB, a to-be-backfilled entry matching the to-be-translated virtual address needs to be looked up from outside the TLB, and the to-be-backfilled entry is written into an idle storage location in the TLB or an existing entry in the TLB is replaced with the to-be-backfilled entry. Therefore, system resources utilized during the address translation process in a TLB miss are much more than system resources utilized during the address translation process in a TLB hit.

A smaller translatable virtual address range for the TLB results in a higher probability of TLB miss and a larger amount of system resources occupied. In addition, when no idle storage unit is available in the TLB, an entry already stored in the TLB needs to be replaced with a to-be-backfilled entry for each TLB miss, and frequent replacement of the entries stored in the TLB may also decrease a TLB hit rate.

Therefore, when an upper limit is present for a quantity of entries that can be cached in the TLB, a larger translatable virtual address range is needed for the TLB in order to increase the TLB hit rate and improve the system performance.

### SUMMARY OF THE INVENTION

In view of this, embodiments of the present invention provide a storage management apparatus, a storage management method, a processor, and a system, so as to resolve the foregoing problems.

To achieve this objective, according to a first aspect, the present invention provides a storage management apparatus, including at least one translation look-aside buffer configured to store a plurality of cache entries; an address translation unit configured to translate a virtual address specified by a translation request to a corresponding translation address based on one of the plurality of cache entries; and a control unit coupled to the at least one translation look-aside buffer and configured to expand an address range that the selected cache entry supports.

In some embodiments, the control unit is configured to perform the following operations: when none of the plurality of cache entries is hit by the translation request, acquiring a to-be-backfilled entry that is hit by the translation request; and expanding one of the plurality of cache entries, so that an address range mapped to the expanded cache entry contains an address range mapped to the to-be-backfilled entry.

In some embodiments, the control unit is coupled to a memory used for storing a root page table, and the to-be-backfilled entry comes from the root page table.

In some embodiments, the control unit is adapted to look up an associated entry of the to-be-backfilled entry in the plurality of cache entries and expand the associated entry. The before-expansion associated entry and the to-be-backfilled entry are mapped to a continuous address range, and an address range mapped to the expanded associated entry contains the address range mapped to the to-be-backfilled entry.

In some embodiments, a first virtual page specified for the before-expansion associated entry is contiguous to a second virtual page specified for the to-be-backfilled entry, and a first translation page specified for the before-expansion associated entry is contiguous to a second translation page specified for the associated entry. The expanded associated entry is adapted to translate virtual addresses in the first virtual page and the second virtual page to translation addresses in the first translation page and the second translation page.

In some embodiments, the first virtual page, the second virtual page, the first translation page, and the second translation page have a same page size.

In some embodiments, each of the cache entries is stored in a plurality of registers, and the plurality of registers include: a first register configured to store a virtual address tag to indicate a virtual page mapped to the cache entry; a second register configured to store a translation address tag to indicate a translation page mapped to the virtual page; and a third register configured to store a size flag bit to indicate a page size of the virtual page/the translation page, where the virtual page and the translation page have a same page size.

In some embodiments, during expansion of the associated entry, the control unit is adapted to modify the size flag bit of the associated entry, so that a page size indicated by the expanded associated entry is greater than a page size indicated by the before-expansion associated entry. In some embodiments, the control unit is adapted to determine a quantity of valid bits of the virtual address tag based on the size flag bit.

According to a second aspect, the present invention provides a processor, including the storage management apparatus according to any one of the foregoing embodiments.

In some embodiments, the processor further includes an instruction prefetching unit. The instruction prefetching unit provides the translation request to the address translation unit, and the translation request specifies a virtual address of a prefetching instruction. The address translation unit communicates with a first translation look-aside buffer in the at least one translation look-aside buffer, and provides a translation address of the prefetching instruction to the instruction prefetching unit based on the cache entry provided by the first translation look-aside buffer.

In some embodiments, the processor further includes a load/store unit. The load/store unit provides the translation request to the address translation unit, and the translation request specifies a virtual address of a load/store instruction. the address translation unit communicates with a second translation look-aside buffer in the at least one translation look-aside buffer, and provides a translation address of the load/store instruction to the load/store unit based on the cache entry provided by the second translation look-aside buffer.

According to a third aspect, the present invention provides a computer system, including: the processor according to any one of the foregoing embodiments, and a memory coupled to the processor.

According to a fourth aspect, the present invention provides a storage management method, including: providing a plurality of cache entries; receiving a translation request, to translate a virtual address specified by the translation request to a corresponding translation address based on one of the plurality of cache entries; and expanding an address range that the selected cache entry supports.

In some embodiments, when none of the plurality of cache entries is hit by the translation request, a to-be-backfilled entry that is hit by the translation request is acquired, and one of the plurality of cache entries is expanded, so that an address range mapped to the expanded cache entry contains an address range mapped to the to-be-backfilled entry.

In some embodiments, the to-be-backfilled entry comes from a root page table stored in a memory.

In some embodiments, the storage management method further includes: looking up an associated entry of the to-be-backfilled entry in the plurality of cache entries and expanding an address range mapped to the associated entry; and the before-expansion associated entry and the to-be-backfilled entry are mapped to a continuous address range, and an address range mapped to the expanded associated entry contains the address range mapped to the to-be-backfilled entry.

In some embodiments, a first virtual page specified for the before-expansion associated entry is contiguous to a second virtual page specified for the to-be-backfilled entry, and a first translation page specified for the before-expansion associated entry is contiguous to a second translation page specified for the associated entry. The expanded associated entry is adapted to translate virtual addresses in the first virtual page and the second virtual page to translation addresses in the first translation page and the second translation page.

In some embodiments, the first virtual page, the second virtual page, the first translation page, and the second translation page have a same page size.

In some embodiments, each of the cache entries is stored in a plurality of registers, and the plurality of registers include: a first register configured to store a virtual address tag to indicate a virtual page mapped to the cache entry; a second register configured to store a translation address tag to indicate a translation page mapped to the virtual page; and a third register configured to store a size flag bit to indicate a page size of the virtual page/translation page, where the virtual page and the translation page have a same page size.

In some embodiments, during expansion of the associated entry, the size flag bit of the associated entry is modified, so that a page size indicated by the expanded associated entry is greater than a page size indicated by the before-expansion associated entry.

In some embodiments, a method of determining whether the translation request hits the cache entries includes: determining a quantity of valid bits of the virtual address tag of the cache entry based on the size flag bit; and performing bit-by-bit comparison between the virtual address tag of the cache entry and a corresponding portion of the virtual address specified by the translation request. If consistent, the cache entry hits the translation request; if inconsistent, the cache entry misses the translation request. A quantity of compared bits in the bit-by-bit comparison is equal to the quantity of valid bits.

In some embodiments, the virtual address tag of the expanded associated entry is equal to a same portion between the virtual address tag of the before-expansion associated entry and the virtual address tag of the to-be-backfilled entry.

In some embodiments, the storage management method further includes: when the associated entry corresponding to the to-be-backfilled entry does not exist in the plurality of cache entries, replacing one of the plurality of cache entries with the to-be-backfilled entry. The replaced cache entry is an invalid entry, an idle entry, or a replacement entry selected according to a replacement algorithm.

Compared with a conventional solution, in the storage management method, the storage management apparatus, the processor, and the computer system provided in the embodiments of the present invention, an address space mapped to a single selected cache entry can be dynamically expanded. In a case of good access locality, a match probability between the expanded cache entries and a plurality of incoming translation requests is higher, increasing the TLB hit rate. In addition, a page size mapped to the expanded cache entry is larger, increasing a hit rate of a single expanded cache entry, and an overall address range mapped to the TLB is also expanded, further increasing an overall TLB hit rate. This improves performance of the processor core system, reduces an instruction access time and/or a data access time, and saves software and hardware resources of the system.

### BRIEF DESCRIPTION OF THE DRAWINGS

The above and other objectives, features, and advantages of the present invention will become more apparent by describing the embodiments of the present invention with reference to the following accompanying drawings. In the drawings,

FIG. 1 illustrates a schematic block diagram of a system according to an embodiment of the present invention;

FIG. 2 is a schematic block diagram of a processor 1100 according to an embodiment of the present invention;

FIG. 3 illustrates a schematic block diagram of a storage management unit according to an embodiment of the present invention;

FIG. 4 illustrates a schematic principle diagram of address translation using a TLB;

FIG. 5 illustrates a schematic flowchart of address translation using a TLB; and

FIG. 6 illustrates a schematic flowchart of writing a to-be-backfilled entry into a TLB according to an embodiment of the present invention.

### DETAILED DESCRIPTION OF THE INVENTION

The following describes the present invention based on embodiments. The present invention, however, is not limited to these embodiments. The following description of the present invention gives some specific details. Without the description of such details, the present invention can still be fully understood by those skilled in the art. To avoid confusing the essence of the present invention, well-known methods, processes and procedures are not described in detail. In addition, the accompanying drawings are not necessarily drawn to scale.

The following terms are used herein.

Computer system: A general-purpose built-in system, a desktop, or a server, or another system with information processing capabilities.

Memory: A physical structure located within the computer system and used for storing information. By purpose, memories can be categorized into a primary memory (also referred to an internal memory, or simply referred to as a memory/primary memory) and a secondary memory (also referred to as an external memory, or simply referred to as a secondary memory/external memory). The primary memory is used for storing instruction information and/or data information represented by data signals, for example, used for storing data provided by a processor, or may be used for information exchange between the processor and the external memory. Information provided by the external memory needs to be transferred to the primary memory before being accessible by the processor. Therefore, a memory mentioned herein is generally a primary memory, and a storage device mentioned herein is generally an external memory.

Physical address (Physical Address, PA for short): An address on an address bus. The processor or other hardware may provide a physical address to the address bus to access the primary memory. The physical address can also be referred to as an actual address, a real address, or an absolute address.

Virtual address: An abstract address used by software or a program. A virtual address space may be larger than a physical address space, and a virtual address may be mapped to a corresponding physical address.

Page (paging) management mechanism: The virtual address space is divided into a plurality of parts, each part as a virtual page, and the physical address space is divided into a plurality of parts, each part as a physical page. A physical page is also called a physical address block or a physical address page frame (page frame).

Root page table: Used for specifying a correspondence between a virtual page and a physical page, and usually stored in the primary memory. The root page table contains a plurality of entries, each of which is used to specify some management flags and a mapping relationship between the virtual page and the physical page, so as to translate a virtual address in the virtual page to a physical address in the corresponding physical page.

Cache entry: Some entries in the root page table that may be commonly used can be cached in a translation look-aside buffer for easy invoking during address translation, so as to accelerate the address translation process. As distinguished from the entries in the root page table, the entries stored in the TLB are referred to as cache entries below.

The embodiments of this application may be applied to the Internet, Internet of Things (Internet of Things, IoT for short), or other systems, for example, a 5G mobile Internet system or an automatic driving system, to increase a TLB hit rate during address translation. However, it should be understood that the embodiments of the present invention are not limited thereto and may be further applied in any scenario in which address translation is needed.

System Overview

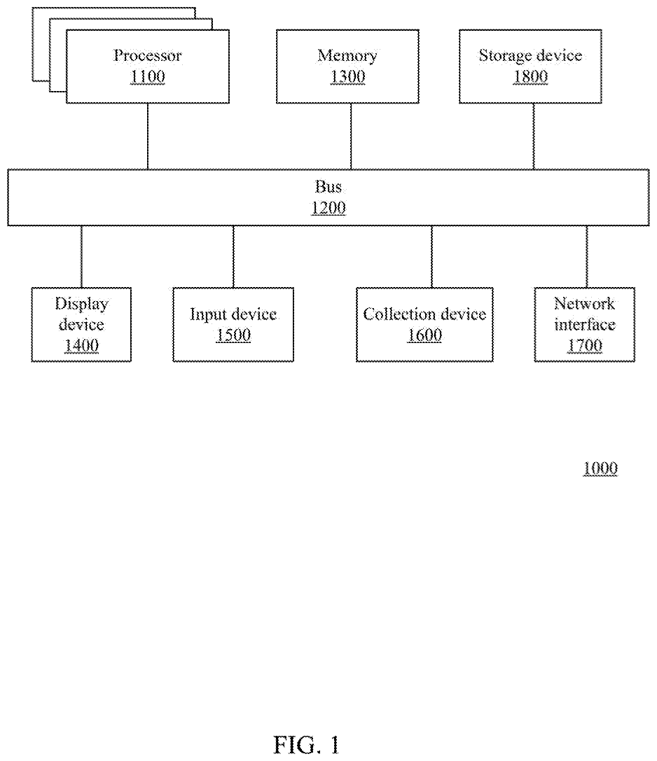

FIG. 1 illustrates a schematic block diagram of a computer system according to an embodiment of the present invention. A computer system 1000 shown in FIG. 1 is intended to show at least some components of one or more electronic apparatuses. In other embodiments of the present invention, some components shown in FIG. 1 may be omitted, the components may be connected through a different architecture, or some hardware and/or software modules not shown in FIG. 1 may also be included. Alternatively, two or more components shown in FIG. 1 may be integrated as one component in a software system and/or a hardware system.

In some embodiments, the computer system 1000 may be applied to a mobile device, a hand-held device, or a built-in device, for example, being applied to smart phones using the 5G technology or a processing platform of autonomous vehicles. The computer system 1000 may also be applied to an Internet of Things device, a wearable device (such as a smart watch or smart glasses), or a device such as a television or a set-top box.

As shown in FIG. 1, the computer system 1000 may include one or more processors 1100. For example, the computer system 1000 may be a terminal system containing at least one processor, a workstation system containing a plurality of processors, or a server system containing a large number of processors or processor cores. The one or more processors 1100 in the computer system 1000 may be independently packaged chips or integrated circuits integrated in a system-on-chip (SoC). The processor 1100 may be a central processing unit, a graphics processing unit, a physical processing unit, or the like.

As shown in FIG. 1, the computer system 1000 further includes a bus 1200, and the processor 1100 may be coupled to one or more buses 1200. The bus 1200 is configured to transmit signals, for example, transmitting address, data, or a control signals between the processor 1100 and other components of the computer system 1000. The bus 1200 may be a processor bus, such as a direct media interface (Direct Media Interface, DMI) bus. However, an interface bus 1200 in this embodiment of the present invention is not limited to using a DMI bus as the interface bus, and may alternatively include one or more interconnect buses, for example, a peripheral component interconnect (Peripheral Component Interconnect, PCI)-based bus, a memory bus, or another type of bus.

In some embodiments, as shown in FIG. 1, the computer system 1000 further includes a memory 1300. As a primary memory of the computer system, the memory 1300 may be a dynamic random access memory (Dynamic Random Access Memory, DRAM), a static random-access memory (Static Random-Access Memory, SRAM), or another module with a storage capability. In some embodiments, the memory 1300 may be configured to store data information and instruction information to be used by one or more processors 1100 during execution of application programs or processes. In addition, the computer system 1000 may include one or more storage devices 1800 serving as secondary memories to provide an additional storage space.

The computer system 1000 may alternatively be coupled to a display device 1400, such as a cathode ray tube (CRT), a liquid crystal display (LCD), or an organic light emitting diode (OLED) array, via the bus 1200 to display information needed by a user.

In some embodiments, the computer system 1000 may include an input device 1500, such as a keyboard, a mouse, and a touch panel, configured to transmit corresponding information of a user operation to a corresponding processor 1100 via the bus 1200. The computer system 1000 may alternatively include a collection device 1600, which may be coupled to the bus 1200 to transmit an instruction and data related to collectable information such as images/sound. For example, the collection device 1600 is a microphone and/or a device such as a video camera or a camera for collecting images. Data provided by the input device 1500 and the collection device 1600 can be stored in a corresponding storage area of the storage device 1300. Instructions provided by the input device 1500 and the collection device 1600 can be executed by the corresponding processor 1100.

The computer system 1000 may further include a network interface 1700, so that the system can access a network. For example, the network is a local area network (LAN), a wide area network (WAN), a metropolitan area network (MAN), a personal area network (PAN), Bluetooth, cloud, a mobile network (for example, a Long Term Evolution (Long Term Evolution, LTE) network, a 3G network, a 4G network, or a 5G network), an intranet, Internet, or the like. The network interface 1700 may include a wireless network interface having at least one antenna and/or a wired network interface performing communication via a network cable. The network cable may be an Ethernet cable, a coaxial cable, an optical fiber cable, a serial cable, or a parallel cable.

For example, the network interface 1700 may provide access to a LAN according to the IEEE 802.11b and/or 802.11g standard, or provide access to a personal local area network according to the Bluetooth standard. Other wireless network interfaces and/or protocols may also be support, including existing and future communication standards. The network interface 1700 can also use the time division multiple access (TDMI) protocol, the global mobile communication system (GSM) protocol, the code division multiple access (CDMA) protocol, and/or other types of wireless communication protocols.

It should be noted that the above and FIG. 1 are merely intended to provide an exemplary description of the computer system 1000, rather than limiting specific implementation of the computer system 1000. The computer system 1000 may also include other components, such as a data processing unit. Alternatively, various parts of the computer system 1000 described above may be appropriately omitted in an actual application.

Processor

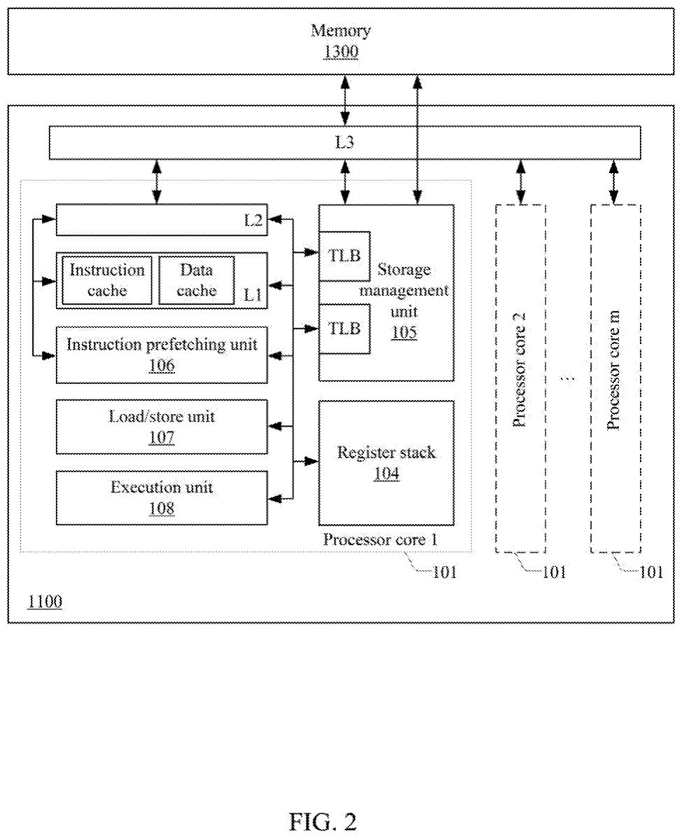

FIG. 2 is a schematic block diagram of a processor 1100 according to an embodiment of the present invention.

In some embodiments, each processor 1100 may include one or more processor cores 101 for processing instructions. Processing and execution of the instructions can be controlled by a user (for example, by using an application program) and/or a system platform. In some embodiments, each processor core may be used to process a specific instruction set. In some embodiments, the instruction set may support complex instruction set computing (CISC), reduced instruction set computing (RISC), or computing based on very long instruction word (VLIW). Different processor cores 101 may process different instruction sets. In some embodiments, the processor core 101 may further include other processing modules, such as a digital signal processor (DSP). As an example, FIG. 2 illustrates processor cores 1 to m, where m is a non-zero natural number.

In some embodiments, as shown in FIG. 2, the processor 1100 may include a cache. Depending on the architecture, the cache in the processor 1100 may be a single or multi-level internal cache (for example, three-level caches L1 to L3 shown in FIG. 2) located within and/or outside each processor core 101, or may include an instruction-oriented cache and data-oriented cache. In some embodiments, various components in the processor 1100 may share at least one part of the cache. As shown in FIG. 2, the processor cores 1 to m share, for example, a level-3 cache L3. The processor 1100 may further include an external cache (not shown), and another cache structure may also serve as an external cache of the processor 1100.

In some embodiments, as shown in FIG. 2, the processor 1100 may include a register stack 104 (Register File). The register stack 104 may include a plurality of registers used for storing different types of data and/or instructions. These registers may be of different types. For example, the register stack 104 may include an integer register, a floating-point register, a status register, an instruction register, a pointer register, and so on. A register in the register stack 104 may be implemented by using a general-purpose register, or may use specific design, depending on an actual requirement of the processor 1100.

The processor 1100 may include a storage management unit (Memory Management Unit, MMU) 105. The storage management unit 105 stores a plurality of cache entries used for translating a virtual address to a physical address. One or more storage management units 105 may be disposed in each processor core 101, and the storage management unit 105 in one processor cores 101 may be synchronized with the storage management unit 105 located in another processor or processor core, so that each processor or processor core can share a virtual storage system.

In some embodiments, an internal interconnect structure is used to make the storage management units 105 interact with other processor cores via the internal bus of the system-on-chip, or directly connect to other modules within the system-on-chip for signal exchange.

The storage management unit 105 may communicate with an instruction prefetching unit 106 used for prefetching instructions in the processor 1100, and/or a load/store unit (LSU) 107 used for loading/storing data.

The instruction prefetching unit 106 accesses the storage management unit 105 by using a virtual address of a prefetching instruction, so as to acquire a translated physical address of the prefetching instruction. The instruction prefetching unit 106 performs addressing in the physical address space by using the physical address generated by the storage management unit 105 through translation, so as to acquire a corresponding instruction. An execution unit in the processor core 101 may receive the instruction acquired by the instruction prefetching unit 106 and processes (for example, decodes) the instruction, so as to execute the instruction.

The load/store unit 107 is an instruction execution unit for a memory access instruction (a load instruction or a store instruction). The load/store unit 107 may be configured to acquire data information from the cache and/or the memory 1300 according to a load instruction, and load the data information onto a corresponding register in the processor 1100. The load/store unit 107 may alternatively store data information of a corresponding register into the cache and/or the memory 1300 according to a storage instruction. The register includes, for example, an address register, a step register, and an address mask register in the register stack 104. The load/store unit 107 accesses the storage management unit 105 based on a virtual address of a memory access instruction, and the storage management unit 105 provides a translated physical address of the memory access instruction to the load/store unit 107, so that the load/store unit 107 can access corresponding data in the physical address space based on the physical address.

It should be noted that the above and FIG. 2 are merely intended to provide an exemplary description of one of the processors in the system, rather than limiting specific implementation of the processor 1100. The processor 1100 may also include other components, such as a data processing unit. Alternatively, various parts of the processor 1100 described above may be appropriately omitted in an actual application.

Storage management unit

The storage management unit 105 may also be referred to as a memory management unit in some cases, or may be a storage management apparatus implemented by hardware and/or software.

In order to better manage an address space exclusively occupied by each process, the computer system 1000 may allocate an independent virtual address space to some processes and provide a mapping relationship between the virtual address and the physical address, so as to map or de-map the virtual address space to or from the physical address space. As mentioned above, because data in the computer system 1000 is usually transmitted in pages, the computer system and/or an operating system running on the computer system usually manages the physical address space and the virtual address space in pages. The virtual address space may be larger than the physical address space, that is, one virtual page in the virtual address space may be mapped to one physical page in the physical address space, or may be mapped to an exchange file, or may not be mapped to any content.

Based on the above paging management mechanism, mapping relationships between virtual pages in the virtual address space and physical pages in the physical address space may be stored as the root page table in the primary memory. The root page table generally includes many entries (Entry). Each entry is used to provide a mapping relationship between a virtual page and a corresponding physical page, so that a virtual address, in a virtual page, that matches the entry can be translated into a corresponding physical address based on the entry.

For a process, a virtual address range corresponding to each virtual page (which may be referred to as a page size of the virtual page) should be consistent with a page size of a corresponding physical page, for example, including but not limited to 4 kB (kilobytes), 8 kB, 16 kB, 64 kB, and the like. What to be added is: for different processes, pages sizes of corresponding virtual pages can be the same or different. Similarly, for different processes, pages sizes of corresponding physical pages may be the same or different. Different options are available in different embodiments.

If the TLB is not disposed, the storage management unit needs to access the memory (for example, a RAM in the storage device 1300) at least twice after receiving a translation request: querying the root page table stored in the memory to acquire an entry matching the translation request (first memory access), and translating a virtual address specified by the translation request to a corresponding physical address based on the entry; and reading instructions and/or data from the memory based on the physical address (second memory access). Consequently, accessing memory a plurality of times deteriorates performance of the processor.

In order to reduce the memory access times of the storage management unit and accelerate the address translation process, as shown in FIG. 2, at least one translation look-aside buffer TLB (also referred to as a fast table, a bypass conversion buffer, a page table buffer, and the like) is disposed in the storage management unit 105, so as to copy entries to be possibly accessed from the memory to the TLB and store the entries as cache entries, so as to cache commonly used mapping relationships between virtual pages and physical pages. Only when a cache entry that matches the virtual address specified by the translation request is not found in the TLB, the storage management unit 105 accesses the root page table in the memory to acquire the corresponding entry. When there is a cache entry in the TLB that matches the virtual address specified by the translation request, the storage management unit 105 can complete the address translation, with no need to access the root page table. Therefore, the TLB can reduce the memory access times of the storage management unit, and reduce the time needed in address translation, improving performance of the processor.

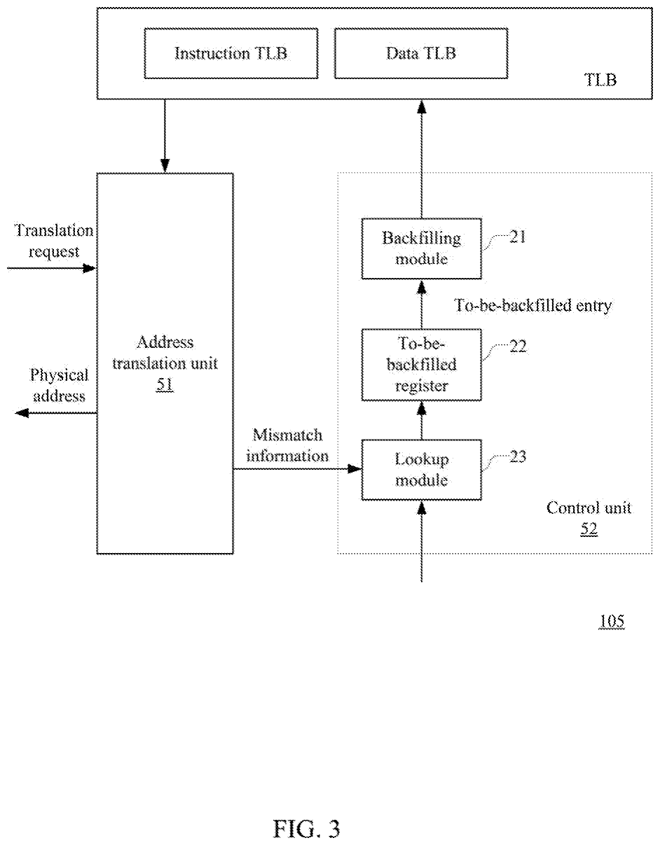

FIG. 3 illustrates a schematic block diagram of a storage management unit according to an embodiment of the present invention.

An instruction storage management unit used for managing instruction storage and/or a data storage management unit used for managing data storage may be independently disposed in the storage management unit 105, depending on different processing objects. The storage management unit 105 may alternatively manage the storage of instructions and data in a centralized manner.

In some embodiments, a plurality of TLBs are disposed in the storage management unit, and different translation look-aside buffers TLBs may be independent of one another or be controlled synchronously. Different TLBs may alternatively be at different levels to form a multi-level buffer structure.

In some embodiments, as shown in FIG. 3, an instruction TLB and a data TLB may be disposed in the storage management unit 105. The instruction TLB is used for caching an instruction cache entry corresponding to an instruction read/write address, and the data TLB is used for caching a data cache entry corresponding to a data read/write address. For example, the instruction TLB is used to receive a translation request sent by the instruction prefetching unit 106 and return a corresponding physical address to the instruction prefetching unit 106. For example, the data TLB is used to receive a translation request sent by the load/store unit 107 and return a corresponding physical address to the load/store unit 107.

As an example, the processor may include four groups of TLBs: The first group of TLBs may be used for caching an instruction cache entry with a relatively small page size, the second group of TLBs may be used for caching a data cache entry with a relatively small page size, the third group of TLBs may be used for caching an instruction cache entry with a relatively large page size, and the fourth TLB may be used for caching a data cache entry with a relatively large page size.

As shown in FIG. 3, the storage management unit 105 may further include an address translation unit 51 and a control unit 52. The address translation unit 51 is configured to look up a corresponding cache entry in the TLB based on a translation request, and translate a virtual address specified by the translation request to a physical address based on the cache entry. When the address translation unit 51 finds no cache entry that matches the to-be-translated virtual address in the TLB, mismatch information may be transmitted to the control unit 52. The control unit 52 acquires a matched entry from the root page table based on the mismatch information, and writes the entry into the TLB as a to-be-backfilled entry, so that one of the cache entries cached in the TLB can match the to-be-translated virtual address. Then, the address translation unit 51 can translate the to-be-translated virtual address into a physical address based on the matched cache entry.

In this embodiment, the control unit 52 may determine whether an address space mapped to the existing cache entry in the TLB is contiguous to an address space mapped to the to-be-backfilled entry. If contiguous, the to-be-backfilled entry is combined with the cache entry in the TLB whose address space is contiguous to that of the to-be-backfilled entry, so that page sizes of a virtual page and a physical page mapped to the combined cache entry are expanded. Correspondingly, a virtual address range of the TLB is expanded. As a result, a TLB hit rate can be increased, and a hit rate of a single cache entry can be increased, improving performance of the processor and the system. If the address space of the to-be-backfilled entry is noncontiguous to that of the existing cache entry in the TLB, the control unit 52 may replace one cache entry in the TLB with the to-be-backfilled entry, and the replaced cache entry is preferentially an invalid or to-be-updated cache entry, an idle cache entry, or a cache entry selected according to a replacement algorithm. The replacement algorithm is, for example, preferentially selecting one of cache entries that have not been referenced recently (for example, a cache entry with a reference bit being set to 0).

As shown in FIG. 3, the control unit 52 may include a to-be-backfilled register 22, a lookup module 23, and a backfilling module 21. The lookup module 23 is configured to read the to-be-backfilled entry matching the to-be-translated virtual address from the memory (or a storage device such as a cache or a hard disk) based on the mismatch information provided by the address translation unit 51. The to-be-backfilled register 22 is configured to temporarily store the to-be-backfilled entry. The backfilling module 21 first determines whether the address space mapped to the existing cache entry in the TLB is contiguous to the address space mapped to the to-be-backfilled entry. If contiguous, the to-be-backfilled entry is combined with the cache entry in the TLB whose address space is contiguous to that of the to-be-backfilled entry. If noncontiguous, the backfilling module 21 proceeds to determine whether there is an idle storage unit (for example, an idle cache entry or an idle register that stores no entry) in the TLB. If there is an idle storage unit in the TLB, the to-be-backfilled entry is preferentially written into the idle storage unit as a new cache entry. If all storage units in the TLB have stored cache entries, the backfilling module may replace one existing cache entry in the TLB with the to-be-backfilled entry.

It should be noted that the above and FIG. 3 are merely intended to provide an exemplary description of one of the storage management units in the computer system, rather than limiting specific implementation of the storage management unit 105. The storage management unit 105 may further include other components. Alternatively, various parts of the storage management unit 105 described above may be appropriately omitted in an actual application.

Translation look-aside buffer

In this embodiment of the present invention, the translation look-aside buffer TLB may include hardware components and/or software programs, which are, for example, implemented by a plurality of registers. Each cache entry may be stored independently in a corresponding register, and the TLB may also include a register for storing instructions such as a read instruction and a write instruction. Because a quantity of cache entries that can be stored in the TLB is limited by hardware resources, the quantity of cache entries in the TLB represents a quantity of potential requests for which the processor can implement a lossless address translation process using the TLB.

In this embodiment, a fully associative manner is used as an example to describe a mapping manner between a virtual address and a TLB entry. To be specific, the virtual address can be mapped to any entry in the root page table in the TLB entries, not being limited by specified bits of a virtual address or a physical address. However, the embodiments of the present invention are not limited thereto. In some other embodiments, a mapping manner between a virtual address and a TLB entry may alternatively be a direct mapped manner, a set associative manner, or another mapping manner.

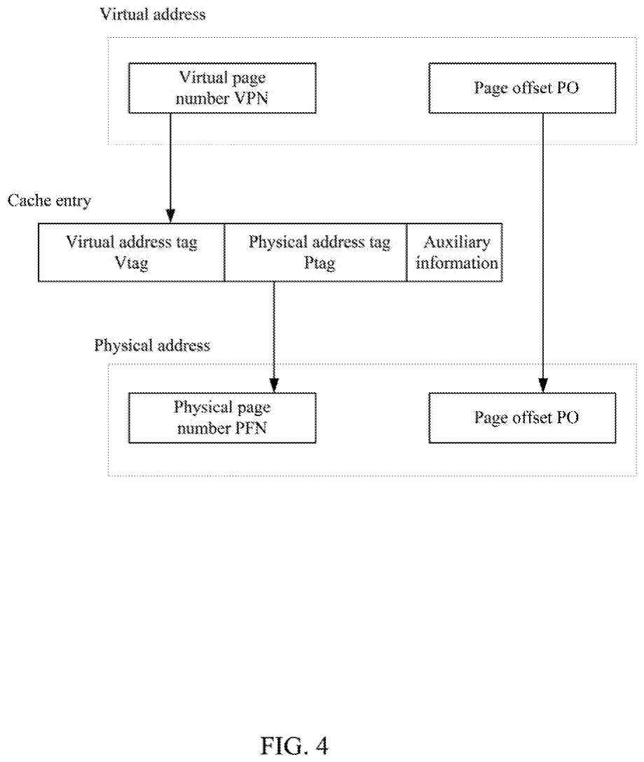

FIG. 4 illustrates a schematic principle diagram of address translation using a TLB.

In an example, a 32-bit address (which may be a virtual address or a physical address) is used and an address within each page (which may be a virtual page or a physical page) is corresponding to 1B (Byte, byte). If a page size is 4 kB, a page offset for each address A[31:0] in the page is PO_4 k=A[11:0] and a page number is PN_4 k=A[31:12]. If the page size is 8 kB, the page offset for each address A[31:0] in the page is PO_8 k=A[12:0] and the page number is PN_8 k=A[31:13]. Because mapping between the virtual address and the physical address may be mapping between the pages, and the virtual page has a same size as the physical page mapped to the virtual page, the virtual address has a same page offset as the physical page mapped to the virtual page. The following uses this as an example to describe a process of address translation using the TLB in this embodiment of the present invention. However, it should be noted that this embodiment of the present invention is not limited thereto. The virtual page or the physical page may have another page size (for example, 64 kB or 32 kB). The virtual address or the physical address may be in another format (for example, 64-bit or 128-bit). In some other embodiments, a position setting and division manner of the page number and the page offset that are included in the virtual address (or the physical address) may be different.

As shown in FIG. 4, the virtual address specified by the translation request can be translated to the corresponding physical address through a cache entry that matches the virtual address. A data structure of each cache entry in the TLB may include a virtual address tag Vtag, a physical address tag Ptag, auxiliary information, and the like.

The virtual address tag Vtag is used to determine whether the cache entry matches the to-be-translated virtual address. Based on the above analysis, it can be learned that the virtual page number may be used to identify the virtual page. Therefore, the virtual address tag Vtag of the cache entry and the virtual page number VPN of the virtual page mapped to the cache entry may be set to a same binary code, and the physical address tag of the cache entry and the physical page number PFN (page frame number) of the physical page mapped to the cache entry may be set to a same binary code. When the virtual page number VPN of the to-be-translated virtual address is consistent with the virtual address tag Vtag of the cache entry, it indicates a hit for the cache entry. In this case, because the virtual address has the same page offset PO as the physical address mapped to the virtual address, the physical address tag Ptag (virtual page number used to replace the virtual address) provided by the matched cache entry and the page offset PO of the to-be-translated virtual address can be combined into the physical address mapped to the to-be-translated virtual address, completing translation.

For a cache entry in the TLB, a page size of a virtual page mapped to the cache entry is equal to a page size of a physical page mapped to the cache entry. Therefore, the page size of the virtual page mapped to the cache entry and the page size of the physical page mapped to the cache entry are collectively referred to as a page size mapped to the cache entry herein.

In this embodiment of the present invention, different cache entries may be mapped to different page sizes, and the page sizes mapped to the cache entries can be expanded. As an example, a cache entry E1 may be mapped to a 4 kB virtual page VP1_4 k and a corresponding 4 kB physical page PP1_4 k. That is, a virtual address tag Vtag1 of the cache entry E1 may be mapped to the virtual page VP1_4 k, and a physical address tag Ptag1 of the cache entry E1 may be mapped to the physical page PP1_4 k. As another example, a cache entry E2 may be mapped to a 8 kB virtual page VP2_8 k and a corresponding 8 kB physical page PP2_8 k. That is, a virtual address tag Vtag2 of the cache entry E2 may be mapped to the virtual page VP2_8 k, and a physical address tag Ptag2 of the cache entry E2 may be mapped to the physical page PP2_8 k.

To indicate a page size mapped to each cache entry, the auxiliary information of the cache entry may include a size flag bit, and the size flag bit may be a binary code of one or more bits. In some embodiments, the cache entry may be mapped to a 4 kB or 8 kB page. In this case, a size flag bit of the cache entry mapped to the 4 kB page size may be set to 0, and a size flag bit of the cache entry mapped to the 8 kB page size may be set to 1. When a page size mapped to a cache entry changes from 4 kB to 8 kB, the size flag bit can be updated from 0 to 1. It should be noted that this embodiment of the present invention is not limited thereto. The cache entry may alternatively be mapped to another page size, that is, each cache entry in the TLB may be mapped to one of a plurality of page sizes, and a bit quantity of the size flag bit S can also be correspondingly set according to a type of the page size.

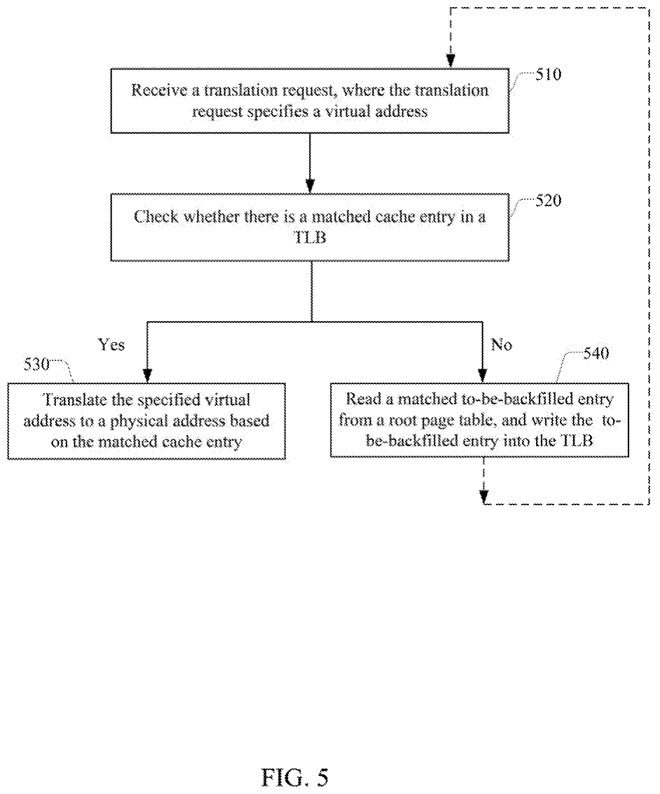

After receiving the translation request, the virtual page number VPN of the to-be-translated virtual address may be compared with the virtual address tag Vtag of each cache entry to find a matched cache entry. The size flag bit can be used to indicate a quantity of valid bits (namely, bits used to compare with the virtual address during lookup) of the virtual address tag. For example, the cache entry E1 is mapped to the 4 kB virtual page VP1_4 k. Assuming that a size flag bit S1 of the cache entry E1 is 0, it indicates that a quantity of bits of the virtual address tag Vtag1 contained in the cache entry E1 is 20. The 20 bits can be compared with the 20-bit virtual page number of the to-be-translated virtual address, to determine whether they are matched. The cache entry E2 shown in FIG. 5 is mapped to the 8 kB virtual page VP2_8 k. Assuming that a size flag bit S2 of the cache entry E2 is 1, it indicates that a quantity of bits of the virtual address tag Vtag2 contained in the cache entry E2 is 19. The 19 bits can be compared with the 19-bit virtual page number of the to-be-translated virtual address, to determine whether they are matched.

In other embodiments, alternatively, no size flag bit is set for the cache entries. For example, in some other embodiments, a cache entry may use another flag bit to indicate how many times the cache entry has been expanded. Further, in some embodiments, a cache entry that has been expanded for a relatively large quantity of times indicates a lower replacement priority.

The auxiliary information of each cache entry may include a validity bit to indicate a status of each cache entry. In some scenarios, for example, after a process switching or root page table update operation is performed, a translation relationship provided by the cache entry may be no longer applicable to the current situation. In this case, the validity bit of the corresponding cache entry may indicate an invalid state (which is, for example, an invalid level or 0), indicating that the cache entry cannot be used in the current address translation process and can be replaced or overwritten. When the validity bit of the cache entry indicates a valid state (which is, for example, a valid level or 1), it indicates that the cache entry can be used in the current translation process. In some embodiments, when there is still an idle storage space in the TLB that can be used for storing a cache entry, the idle storage space may also be equivalent to a cache entry being in an invalid state. A validity bit of the cache entry indicates an invalid state, and is used to indicate that the idle storage space can be used for writing a new cache entry.

It should be noted that in the following description, all the matched cache entries are cache entries being in the valid state.

In some embodiments, when one of the cache entries in the TLB needs to be replaced, a replaceable cache entry may be selected based on frequency of using the cache entry. For example, a least recently used cache entry is replaced according to an LRU (Least Recently Used, least recently used) algorithm. To indicate the frequency of use, the auxiliary information of the cache entry may include a reference bit. The reference bit may be a binary code of one or more bits. When a cache entry is used for translation, a reference bit of the cache entry may be updated to indicate a higher frequency of use (or a reference code of another cache entry is updated to indicate a lower frequency of use). In this way, during execution of the LRU algorithm, a replaceable cache entry can be selected based on the reference bits of the cache entries.

In some embodiments, the auxiliary information of the cache entry may further include a dirty bit (dirty) to indicate whether an address space in the memory has been modified. The dirty bit may also be a binary code of one or more bits.

In some embodiments, the auxiliary information of the cache entry may further include another indication bit, for example, to indicate a process flag number, a page read/write permission, a page address attribute, and the like that are associated with the page.

It should be noted that although the virtual address tag, the physical address tag, and the auxiliary information of each cache entry are arranged in an upper-to-lower bit order in the foregoing description and the description of FIG. 4, the embodiments of the present invention are not limited thereto. The virtual address tag, the physical address tag, and the auxiliary information, such as a size flag bit and a validity bit, of each cache entry may be arranged in a different order. For example, the size flag bit may be located at the uppermost bit of the cache entry, to facilitate identification of a page size corresponding to the cache entry.

Address Translation Process

FIG. 5 illustrates a schematic flowchart of address translation using a TLB. The following provides an exemplary description of a translation process from a virtual address to a physical address with reference to FIG. 5.

Step 510 shown in FIG. 5 is receiving a translation request. The translation request specifies a to-be-translated virtual address, such as a virtual address of a prefetching instruction or a virtual address of a load instruction.

Step 520 shown in FIG. 5 is checking whether there is a virtual address tag matching a virtual page number of the to-be-translated virtual address in cache entries, so as to determine whether there is a TLB hit.

In step 520, if a virtual address tag of a cache entry in the TLB is consistent with the virtual page number of the to-be-translated virtual address and the cache entry is in a valid state (that is, the cache entry can be used for translation, for example, a validity bit of the cache entry is at a valid level), it indicates that a matched cache entry is stored in the TLB, and then step 530 is performed. If the virtual page number of the to-be-translated virtual address is inconsistent with virtual address tags of all cache entries in the TLB, it indicates that there is no cache entry in the TLB that matches the translation request, and then step 540 is performed.

In some embodiments, step 520 may include: comparing an N-bit binary code representing the virtual page number in the to-be-translated virtual address with the virtual address tag of each cache entry. As described above, each cache entry may be mapped to a different page size, and a size flag bit of each cache entry may indicate a quantity of valid bits of a corresponding virtual address tag. Therefore, a value of N may be determined based on the size flag bit of each cache entry, and N is a natural number greater than or equal to 1.

As an example, when the quantity of valid bits of the virtual address tag of the cache entry to be compared is 8, the size flag bit is set to 0, and N=8. The virtual address tag of the cache entry is compared with the upper eight bits of the to-be-translated virtual address. If the two are consistent, it is determined that the cache entry matches the to-be-translated virtual address; otherwise, the cache entry does not match the to-be-translated virtual address. When the quantity of valid bits of the virtual address tag of the cache entry to be compared is 7, the size flag bit is set to 1, and N=7. The virtual address tag of the cache entry is compared with the upper seven bits of the to-be-translated virtual address. If the two are consistent, it is determined that the cache entry matches the to-be-translated virtual address, otherwise, the cache entry does not match the to-be-translated virtual address.

It should be noted that words such as “upper eight bits” and “upper seven bits” are examples that are merely intended to limit that the quantity of bits, being compared with each virtual address tag, in the to-be-translated virtual address is consistent with the quantity of bits in the virtual address tag, and may be located in other positions in other examples to indicate at least a portion of the virtual page number of the virtual address.

In some embodiments, during execution of step 520, if a cache entry is hit, the lookup process may be terminated, with no need to further compare virtual address tags of remaining cache entries with the to-be-translated virtual address, thereby saving resources.

In a case of a TLB hit, in step 530 shown in FIG. 5, a physical address may be generated based on a matched cache entry. In this way, the virtual address is translated to the physical address by using the TLB. Because of the TLB hit, the cache entries stored in the TLB can be used directly for address translation. This process does not consume excessive resources and causes no loss to performance of the processor and the system.

In some embodiments, as described above, during generation of the physical address, the physical address tag of the matched cache entry and a page offset of the to-be-translated virtual address can be combined into the corresponding physical address.

In a case of a TLB miss, in step 540 shown in FIG. 5, a to-be-backfilled entry that matches the to-be-translated virtual address may be found from the root page table (which is stored in a storage device such as a memory or a hard disk), and then the to-be-backfilled entry is written into the TLB, thereby implementing TLB updating.

In some embodiments, when a TLB miss is determined, mismatch information (at least including the virtual page number of the to-be-translated virtual address, or including all bits of the to-be-translated virtual address) may be first generated based on the to-be-translated virtual address, to then access the root page table based on the mismatch information, so as to find an entry matching the to-be-translated virtual address based on the mismatch information and use the entry as the to-be-backfilled entry.

In some embodiments, after step 540 is completed, a translation request (corresponding to the same virtual address as that of the translation request described in step 510) may be initiated again, and then steps 520 to 530 are performed accordingly, so as to use the updated TLB for translation to acquire a corresponding physical address.

In other embodiments, after step 540 is completed, an updated cache entry in the TLB may alternatively be used directly for translating a to-be-translated virtual address to acquire a corresponding physical address. This omits the process of lookup in all cache entries in the TLB.

It can be learned from the foregoing description of step 540 that, in a case of a TLB miss, a plurality of steps need to be performed, for example, look up the matched entry in the root page table, reading the to-be-backfilled entry, writing the to-be-backfilled entries into the TLB, and performing translation based on the updated TLB. This needs a plurality of execution cycles and occupies a relatively large amount of system resources, limiting performance of the processor and the computer system. Therefore, minimizing a probability of TLB miss, that is, increasing a TLB hit rate, is expected, and the TLB needs to be mapped to a larger address range. It is assumed that an address range of TLB mapping is equal to a quantity of cache entries multiplied by a page size mapped to each cache entry, and the quantity of cache entries stored in the TLB is limited by hardware resources. In this case, under a premise that the TLB contains a finite quantity of cache entries, the TLB hit rate can be increased by expanding a page size mapped to a single cache entry in this embodiment of the present invention.

In this embodiment of the present invention, a process of expanding an address range mapped to a single cache entry may be performed in the foregoing step 540, or may be performed in a TLB initialization process or another process in which the TLB needs to be updated. The following description uses the backfilling process of writing a to-be-backfilled entry to the TLB in a TLB miss as an example. In the backfilling process, the page size mapped to the single cache entry that is stored in the TLB can be expanded under some conditions. However, this embodiment of the present invention is not limited thereto, and a method of expanding the address range mapped to the single cache entry may also be applied to other processes of address translation using the TLB. For example, according to this embodiment of the present invention, whether two cache entries are mapped to a contiguous address range may be checked in the initialization phase or another working phase of the TLB. If the contiguous address range is present, the two cache entries may be combined into one cache entry to expand the address range mapped to the single cache entry. The combination manner is the same as that provided in the following embodiments, and is not described here. In other alternative embodiments, the address range mapped to the single cache entry may alternatively be expanded directly as needed, rather than being limited to combining the cache entry and another entry (or cache entry) to expand the address range mapped to the cache entry.

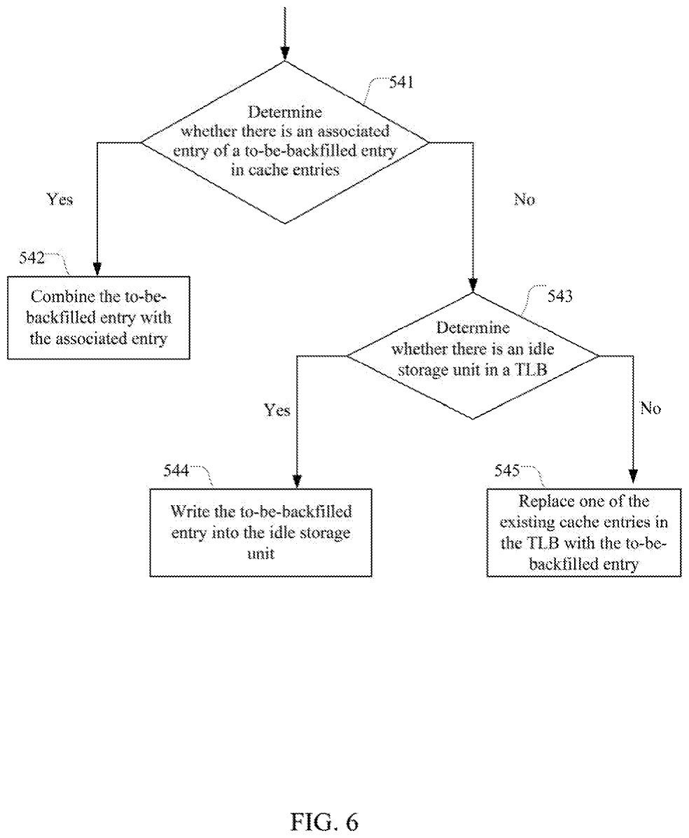

FIG. 6 illustrates a schematic flowchart of writing a to-be-backfilled entry into a TLB according to an embodiment of the present invention.

In step 541 shown in FIG. 6, it is determined whether each cache entry is an associated entry of the to-be-backfilled entry. A condition for determining that each cache entry is an associated entry of the to-be-backfilled entry is that an address range of a virtual page mapped to the to-be-backfilled entry is contiguous to an address range of a virtual page mapped to the cache entry, and that an address range of a physical page mapped to the to-be-backfilled entry is contiguous to an address range of a physical page mapped to the cache entry.

Whether the address ranges of the pages are contiguous can be determined in a plurality of manners, of which two are used below for description.

<Manner 1>

In some embodiments, the step of determining whether the address ranges of the virtual pages are contiguous may include: If the largest address of a virtual page mapped to a cache entry is contiguous to the smallest address of the virtual page mapped to the to-be-backfilled entry, or if the smallest address of the virtual page mapped to the cache entry is contiguous to the largest address of the virtual page mapped to the to-be-backfilled entry, it indicates that an address range of the virtual page mapped to the cache entry is contiguous to the address range of the virtual page mapped to the to-be-backfilled entry.

Similarly, the step of determining whether the address ranges of the physical pages are contiguous may include: If the largest address of a physical page mapped to a cache entry is contiguous to the smallest address of the physical page mapped to the to-be-backfilled entry, or if the smallest address of the physical page mapped to the cache entry is contiguous to the largest address of the physical page mapped to the to-be-backfilled entry, it indicates that an address range of the physical page mapped to the cache entry is contiguous to the address range of the physical page mapped to the to-be-backfilled entry.

<Manner 2>

Because the smallest or largest addresses of the virtual page and physical page include multi-bit page offsets, one-by-one comparison may consume a lot of system resources. Therefore, to simplify steps and save time and system resources, in some embodiments, conditions for determining that a cache entry is an associated entry of the to-be-backfilled entry may further include that the page size mapped to the cache entry is the same as the page size mapped to the to-be-backfilled entry.

Based on this determining condition, the virtual address tag of the to-be-backfilled entry is adjacent to the virtual address tag of the associated entry (which may correspond to an adjacent virtual page number), and the physical address tag of the to-be-backfilled entry is adjacent to the physical address tag of the associated entry (which may correspond to the adjacent physical page number).

Therefore, in manner 2, during determining of whether a cache entry is the associated entry of the to-be-backfilled entry, it may be determined whether the virtual address tag of the to-be-backfilled entry is adjacent to the virtual address tag of the cache entry, and whether the physical address tag of the to-be-backfilled entry is adjacent to the physical address tag of the cache entry. If the virtual address tag and the physical address tag of the cache entry are adjacent to the virtual address tag and the physical address tag of the to-be-backfilled entry respectively, the cache entry can be determined as the associated entry of the to-be-backfilled entry.

The following provides description with reference to a specific example.

As an example, a virtual address tag Vtag0 of a to-be-backfilled entry E0 is mapped to, for example, a virtual page VP0. A physical address tag Ptag0 of the to-be-backfilled entry E0 is mapped to, for example, a physical page PP0. A page number of the virtual page VP0 is, for example, VPN0=02H=Vtag0=0000 0010, and page offsets of virtual addresses in the virtual page VP0 are 000H to FFFH. A page number of the physical page PP0 is, for example, PFN0=12H=Ptag0=0001 0010, and page offsets of physical addresses in the physical page PP0 are 000H to FFFH. In this case, a page number VPNx of a virtual page VPx mapped to an associated entry Ex of the to-be-backfilled entry E0 is 03H (that is, a virtual address tag Vtagx of the associated entry Ex may be 03H=0000 0011, adjacent to the virtual address tag Vtag0 of the to-be-backfilled entry E0). In addition, a page number PFNx of a physical page PPx mapped to the associated entry Ex is 13H (that is, a physical address tag Ptagx of the associated entry Ex may be 13H=0001 0011, adjacent to the physical address tag Ptag0 of the to-be-backfilled entry E0).

In addition, the page number VPNx of the virtual page VPx mapped to the associated entry Ex of the to-be-backfilled entry E0 may alternatively be 01H (that is, the virtual address tag Vtagx of the associated entry Ex may be 01H=0000 0001, adjacent to the virtual address tag Vtag0 of the to-be-backfilled entry E0), and the page number PPNx of the physical page PPx mapped to the associated entry Ex is 11H (that is, the physical address tag Ptagx of the to-be-backfilled entry Ex may be 11H=0001 0001, adjacent to the physical address tag Ptag0 of the to-be-backfilled entry E0).

In some optional embodiments, a size flag bit of a cache entry is compared with a size flag bit of the to-be-backfilled entry to determine whether the page size mapped to the cache entry is the same as the page size mapped to the to-be-backfilled entry. In this way, a quantity of bits of the virtual address tag used for comparison in each cache entry can be learned.

It should be noted that, based on the foregoing determining principle, the cache entries may not include an associated entry of the to-be-backfilled entry, or may include one or more cache entries that may be used as an associated entry. When there are a plurality of cache entries that can be used as the associated entry in the TLB, one of the plurality of cache entries may be selected as the associated entry of the to-be-backfilled entry in a preset manner, for example, the first determined associated entry in step 541 is selected.

As shown in FIG. 6, after step 541 is performed, if the associated entry corresponding to the to-be-backfilled entry is found from the cache entries, step 542 is performed.

In step 542, the to-be-backfilled entry is combined with the associated entry to expand a page size mapped to the associated entry.

It can be learned from the foregoing analysis that the virtual page mapped to the to-be-backfilled entry and the virtual page mapped to the associated entry are contiguous in the virtual address space, and the physical page mapped to the to-be-backfilled entry and the physical page mapped to the associated entry are contiguous in the physical address space. In this case, the to-be-backfilled entry can be combined with the associated entry, so that an address range of a virtual page mapped to the combined associated entry is equal to a range acquired by adding up the virtual address range mapped to the to-be-backfilled entry and the virtual address range mapped to the before-combination associated entry, and an address range of a physical page mapped to the combined associated entry is equal to a range acquired by adding up the physical address range of the before-combination associated entry and the physical address range mapped to the to-be-backfilled entry.

The combined associated entry is still stored in the TLB as one of the cache entries, and a page size represented by a size flag bit of the combined associated entry is greater than the page size mapped to the before-combination associated entry.

As an example, the virtual address tag Vtag0 of the to-be-backfilled entry E0 is 0000 0010, and the virtual address tag Vtagx of the associated entry Ex of the to-be-backfilled entry is 0000 0011. Then, a virtual address tag Vtagx′ of the combined associated entry Ex′ is 0000 001 (which may be the same part between the virtual address tag of the to-be-backfilled entry E0 and the virtual address tag of the before-combination associated entry Ex′). The virtual page mapped to the combined associated entry Ex′ includes both virtual addresses mapped to the before-combination associated entry Ex and those mapped to the to-be-backfilled entry E0. After backfilling is completed, if upper seven bits (indicating at least one portion of a page number) of a to-be-translated virtual address are equal to the virtual address tag Vtagx′ of the combined associated entry, it indicates that the combined associated entry is hit. A physical address tag mapped to the combined associated entry can be used to replace the upper seven bits of the to-be-translated virtual address, and then is combined with remaining bits of the to-be-translated virtual address to form the physical address mapped to the to-be-translated virtual address.

It can be learned that a quantity of bits of the virtual address tag being compared to the to-be-translated virtual address changes after entry combination. Therefore, as described above, a quantity of bits of a to-be-compared virtual address tag can be determined based on the size flag bit during the process of determining whether there is a TLB hit.

For example, when the TLB allows storage of two types of cache entries (mapped to different page sizes), the size flag bit can be set to one bit. However, when the TLB allows storage of more than two types of cache entries (mapped to different page sizes), the size flag bit can be set to a plurality of bits.

The size flag bit may also be used to determine whether further combination of a cache entry is allowed. To be specific, when the size flag bit of the cache entry indicates a maximum page size allowed by the TLB, the cache entry cannot be combined with another entry. When the size flag bit of the cache entry does not indicate the maximum page size allowed by the TLB, the cache entry may be combined with another entry, and the size flag bit of the cache entry indicates a combined page size after the combination is completed.

To simplify a backfilling mechanism, in some embodiments, the TLB may allow storage of only two types of cache entries, mapped to pages of a first page size and a second page size, respectively. The second page size is two times of the first page size. Based on this, the backfilling process allows combination of only a to-be-backfilled entry mapped to the first page size and an associated entry mapped to the first page size in the TLB, and a combined associated entry maps to the second page size. Therefore, the size flag bit of each cache entry may be set to one bit. When a cache entry is mapped to the first page size, the size flag bit of the cache entry may be 0. When the cache entry is an associated entry of a to-be-backfilled entry, the cache entry and the to-be-backfilled entry may be combined into a cache entry (combined associated entry) mapped to the second page size, and a size flag bit of the combined associated entry changes to 1. When a cache entry is mapped to the second page size, a size flag bit of the cache entry may be 1, and the cache entry cannot be combined with the to-be-backfilled entry.

As an example, an associated entry Ex of a to-be-backfilled entry before combination has a size flag bit set to 0, indicating that a quantity of valid bits of a virtual address tag is 8 bits and that a page size mapped to the associated entry is, for example, 4 kB. However, a size flag bit of a combined associated entry Ex′ is set to 1, indicating that a quantity of valid bits of the virtual address tag is 7 bits and that a page size mapped to the combined associated entry is, for example, 8 kB, twice the page size mapped to the before-combination associated entry Ex.

As shown in FIG. 6, if the associated entry corresponding to the to-be-backfilled entry is not found after step 541 is performed, step 543 is performed.

In step 543, it is determined whether there is an idle storage unit in the TLB. If yes, step 544 is performed to write the to-be-backfilled entry into the idle storage unit, for example, to write the to-be-backfilled entry into an unoccupied idle register in the TLB, completing the backfilling process. If not, step 545 is performed, that is, selecting a preferentially replaceable cache entry from the TLB according to a replacement algorithm, and replacing the selected cache entry with the to-be-backfilled entry.

In some embodiments, as described above, the replacement algorithm may be an LRU algorithm and is used to select a least recently used cache entry as the preferentially replaceable cache entry based on frequency of using the cache entries. For example, the LRU algorithm is to determine, based on a reference bit of each cache entry, the frequency of using the cache entry.

However, this embodiment of the present invention is not limited thereto. In this embodiment of the present invention, another replacement algorithm may alternatively be used to select a preferentially replaceable cache entry. For example, the replacement algorithm may alternatively be selecting a preferentially replaceable cache entry based on a size flag bit of each cache entry, that is, selecting a least recently used cache entry as the preferentially replaceable cache entry from cache entries whose size flag bits indicates a relatively small address space size.

In addition, as described above, in some embodiments in which validity bits are set for cache entries, whether a validity bit of each cache entry in the TLB indicates an invalid state is determined, so as to determine whether the TLB includes an idle storage unit that can be used for writing a new cache entry (which may, for example, be equivalent to a cache entry whose validity bit is set to 0). Further, if the TLB includes two or more idle storage units, one of the idle storage units may be selected as a storage unit of the to-be-backfilled entry based on an order of the cache entries (for example, to be determined based on flag bits used for indicating entry numbers in the virtual address tags of the cache entries).

So far, the method of writing the to-be-backfilled entry into the TLB is described by using the examples, that is, the process of updating the TLB is described. In a subsequent step, each updated cache entry can be used to translate a to-be-translated virtual address to a corresponding physical address in a case of a hit. The storage management method provided in this embodiment of the present invention has been also described in the foregoing embodiments.

When the processor executes a segment of programs, contiguous virtual addresses accessed by the processor are usually mapped to contiguous physical addresses based on the principle of program access locality, regardless of data access or instruction access. Therefore, based on the above paging management mechanism, page allocation features very strong continuity. A phenomenon arising from the access locality principle may include: time locality, that is, information being accessed is likely to be accessed again in the near future, and such phenomenon may be caused by design such as a program loop or stack; spatial locality, that is, information being used and information to be used are likely to be contiguous or adjacent in address; and sequence locality, that is, most instructions are executed in sequence, and arrays may also be accessed in a consecutive storage sequence.

In a conventional solution, a page size corresponding to each cache entry in the TLB is not scalable; consequently, it is difficult to increase both a TLB hit rate and a hit rate of a single cache entry under a limitation of storing a finite quantity of cache entries in the TLB.

Compared with the conventional solution, in the storage management method and the storage management unit provided in the embodiments of the present invention, a single cache entry can be dynamically expand. Based on the locality principle described above, it can be learned that in a case of good access locality, a match probability between the expanded cache entry and a plurality of incoming translation requests is higher, increasing the hit rate of the single cache entry. In addition, a page size mapped to the expanded cache entry is larger, and an address space available for TLB mapping is expanded, further increasing the overall TLB hit rate. This improves performance of the processor and the computer system, reduces an instruction access time and/or a data access time, and also saves software and hardware resources of the system.

This application further discloses a computer readable storage medium including computer executable instructions stored thereon. When being executed by the processor, the computer executable instruction causes the processor to execute the methods of the embodiments described herein.

In addition, this application discloses a computer system. The computer system includes an apparatus used for implementing the methods of the embodiments described herein.

It should be appreciated that the foregoing descriptions are merely exemplary embodiments of the present invention and are not intended to limit the present invention. For those skilled in the art, there are many variations for the embodiments of this specification. Any modification, equivalent replacement, and improvement made without departing from the spirit and principle of the present invention shall fall within the protection scope of the present invention.

For example, although this specification merely describes the method of translating a virtual address to a physical address by using a TLB, the TLB is not limited to storing a relationship between the virtual address and the physical address. Before the physical address is acquired, some cache entries in the TLB may also translate the virtual address to a translation address. The translation address may be further translated and converted into a physical address, and a translation address space may also be divided into parts based on a paging management mechanism, each part being referred to as a translation page. In addition, in some embodiments, the cache entry in the TLB is used for translating a virtual page in a virtual address space. However, in other embodiments, the cache entry in the TLB may alternatively be used for translating another type of address.

For another example, in some embodiments, the storage management unit may include an enabling register. On/off of the storage management unit may be set by configuring at least one bit value in the enabling register.

In addition, the process of looking up a to-be-backfilled entry in a root page table or looking up a matched cache entry in the TLB may require a plurality of lookups or a multi-level lookup. In different mapping manners, a virtual page number and a physical page number may also be divided into a plurality of parts used for matching a corresponding part of each entry (or cache entry) step by step, so as to implement a multi-level index mapping manner.

It should be understood that the embodiments in this specification are all described in a progressive manner. For same or similar parts in the embodiments, mutual reference may be made, and each embodiment focuses on a difference from other embodiments. In particular, the method embodiment is essentially similar to the method described in the apparatus embodiment and system embodiment, and therefore is described briefly. For related parts, reference may be made to partial descriptions in the other embodiments.

It should be understood that specific embodiments in this specification are described above. Other embodiments fall within the scope of the claims. In some cases, actions or steps described in the claims may be performed in a sequence different from those in the embodiments, and expected results can still be achieved. In addition, illustrated specific sequences or continuous sequences are not necessarily required for the processes described in the drawings to achieve the expected results. In some implementations, multi-task processing and parallel processing are also allowed or may be advantageous.

It should be understood that a component described in a singular form herein or only one component shown in the accompanying drawings does not mean that a quantity of such components is limited to one. In addition, separate modules or components described or shown herein may be combined into one module or component, and one module or component described or shown herein may be split into a plurality of modules or components.

It should be further understood that the terms and expressions used herein are used for description only, and that one or more embodiments of this specification should not be limited to these terms and expressions. Use of these terms and expressions does not imply exclusion of any equivalent features indicated or described (or partial features thereof), and it should be recognized that any possible modifications should also fall within the scope of the claims. Other modifications, changes, and replacements may also exist. Correspondingly, the claims shall be considered to cover all these equivalents.

What is claimed is:

1. A storage management apparatus, comprising:
at least one translation look-aside buffer, configured to store a plurality of cache entries;
an address translation unit, configured to translate a virtual address specified by a translation request to a corresponding translation address based on one of the plurality of cache entries; and
a control unit, coupled to the at least one translation look-aside buffer and configured to expand an address range that one or more of the plurality of cache entries support.

2. The storage management apparatus according to claim 1, wherein the control unit is adapted to perform the following operations:
when none of the plurality of cache entries is hit by the translation request, acquiring a to-be-backfilled entry that is hit by the translation request; and
expanding one of the plurality of cache entries, so that an address range mapped to the expanded one of the plurality of cache entries contains an address range mapped to the to-be-backfilled entry.

3. The storage management apparatus according to claim 2, wherein the control unit is coupled to a memory used for storing a root page table, and the to-be-backfilled entry comes from the root page table.

4. The storage management apparatus according to claim 2, wherein the control unit is adapted to look up an associated entry of the to-be-backfilled entry in the plurality of cache entries and expand the associated entry; and
a before-expansion associated entry and the to-be-backfilled entry are mapped to a continuous address range, and an address range mapped to the expanded associated entry contains the address range mapped to the to-be-backfilled entry.

5. The storage management apparatus according to claim 4, wherein a first virtual page specified for the before-expansion associated entry is contiguous to a second virtual page specified for the to-be-backfilled entry, and a first translation page specified for the before-expansion associated entry is contiguous to a second translation page specified for the associated entry; and
the expanded associated entry is adapted to translate virtual addresses in the first virtual page and the second virtual page to translation addresses in the first translation page and the second translation page.

6. The storage management apparatus according to claim 5, wherein the first virtual page, the second virtual page, the first translation page, and the second translation page have a same page size.

7. The storage management apparatus according to claim 4, wherein each of the cache entries is stored in a plurality of registers, and the plurality of registers comprise:
a first register, configured to store a virtual address tag to indicate a virtual page mapped to the cache entry;
a second register, configured to store a translation address tag to indicate a translation page mapped to the virtual page; and
a third register, configured to store a size flag bit to indicate a page size of the virtual page/the translation page, wherein the virtual page and the translation page have a same page size.

8. The storage management apparatus according to claim 7, wherein during expansion of the associated entry, the control unit is adapted to modify the size flag bit of the associated entry, so that a page size indicated by the expanded associated entry is greater than a page size indicated by the before-expansion associated entry.

9. The storage management apparatus according to claim 7, wherein the control unit is adapted to determine a quantity of valid bits of the virtual address tag based on the size flag bit.

10. A processor, comprising the storage management apparatus according to claim 1.

11. The processor according to claim 10, further comprising an instruction prefetching unit, wherein the instruction prefetching unit provides the translation request to the address translation unit, and the translation request specifies a virtual address of a prefetching instruction; and
the address translation unit communicates with a first translation look-aside buffer in the at least one translation look-aside buffer, and provides a translation address of the prefetching instruction to the instruction prefetching unit based on the cache entry provided by the first translation look-aside buffer.

12. The processor according to claim 10, further comprising a load/store unit, wherein the load/store unit provides the translation request to the address translation unit, wherein the translation request specifies a virtual address of a memory access instruction; and
the address translation unit communicates with a second translation look-aside buffer in the at least one translation look-aside buffer, and provides a translation address of the memory access instruction to the load/store unit based on the cache entry provided by the second translation look-aside buffer.

13. A computer system, comprising:
the processor according to claim 10; and
a memory coupled to the processor.

14. A storage management method, comprising:
providing a plurality of cache entries;
receiving a translation request, to translate a virtual address specified by the translation request to a corresponding translation address based on one of the plurality of cache entries; and
expanding an address range that one of the plurality of cache entries supports.

15. The storage management method according to claim 14, wherein when none of the plurality of cache entries is hit by the translation request, a to-be-backfilled entry that is hit by the translation request is acquired, and one of the plurality of cache entries is expanded, so that an address range mapped to the expanded cache entry contains an address range mapped to the to-be-backfilled entry.

16. The storage management method according to claim 15, further comprising:
looking up an associated entry of the to-be-backfilled entry in the plurality of cache entries and expanding an address range mapped to the associated entry; wherein
a before-expansion associated entry and the to-be-backfilled entry are mapped to a continuous address range, and an address range mapped to the expanded associated entry contains the address range mapped to the to-be-backfilled entry.

17. The storage management method according to claim 16, wherein a first virtual page specified for the before-expansion associated entry is contiguous to a second virtual page specified for the to-be-backfilled entry, and a first translation page specified for the before-expansion associated entry is contiguous to a second translation page specified for the associated entry; and
the expanded associated entry is adapted to translate virtual addresses in the first virtual page and the second virtual page to translation addresses in the first translation page and the second translation page.

18. The storage management method according to claim 16, wherein each of the cache entries is stored in a plurality of registers, and the plurality of registers comprise:
a first register, configured to store a virtual address tag to indicate a virtual page mapped to the cache entry;
a second register, configured to store a translation address tag to indicate a translation page mapped to the virtual page; and
a third register, configured to store a size flag bit to indicate a page size of the virtual page/translation page, wherein the virtual page and the translation page have a same page size.

19. The storage management method according to claim 18, wherein a method of determining whether the translation request hits the cache entries comprises:
determining a quantity of valid bits of the virtual address tag of the cache entry based on the size flag bit; and
performing bit-by-bit comparison between the virtual address tag of the cache entry and a corresponding portion of the virtual address specified by the translation request, wherein if consistent, the cache entry hits the translation request; if inconsistent, the cache entry misses the translation request; wherein
a quantity of compared bits in the bit-by-bit comparison is equal to the quantity of valid bits.

20. The storage management method according to claim 16, further comprising:
when the associated entry corresponding to the to-be-backfilled entry does not exist in the plurality of cache entries, replacing one of the plurality of cache entries with the to-be-backfilled entry, wherein the replaced cache entry is an invalid entry, an idle entry, or a replacement entry selected according to a replacement algorithm.
